(19) United States
(12) Patent Application Publication
(10) Pub. No.: US 2025/0287193 A1
(43) Pub. Date: Sep. 11, 2025

(54) ROAMING IN A MULTI-LINK DEVICE TOPOLOGY

(71) Applicant: Cisco Technology, Inc., San Jose, CA (US)

(72) Inventors: Malcolm M. Smith, Richardson, TX (US); Sudhir K. Jain, Hayward, CA (US); Brian D. Hart, Sunnyvale, CA (US); Kasi R. Nalamalapu, Pleasanton, CA (US)

(21) Appl. No.: 18/598,027

(22) Filed: Mar. 7, 2024

(51) Int. Cl. H04W 8/02; H04W 76/15

(52) U.S. Cl. CPC H04W 8/02; H04W 76/15

(57) ABSTRACT

A method to facilitate roaming from a serving Access Point (AP) to a non-collocated AP is described. The method includes detecting, by an Access Point (AP) actor, that a communication metric characterizing communication between the AP actor and a non-AP actor is indicative of reduced communication quality, in response to detecting, sending a request, by the AP actor, to the non-AP actor for a beacon report for respective link metric values for a plurality of non-collocated AP actors, receiving, in response to the request and from the non-AP actor, the beacon report including the respective link metric values for the plurality of non-collocated AP actors, and based on the respective link metric values for the plurality of non-collocated AP actors, sending, by the AP actor, to the non-AP actor, a list of a subset of the plurality of non-collocated AP actors from which the non-AP actor may select to roam.

### TECHNICAL FIELD

The present disclosure relates to systems and methodologies to enable client multi-link device (MLD) roaming in a mobility domain including both collocated MLD Access Points (APs) and non-collocated MLD APs.

### BACKGROUND

Wireless local area network (WLAN) technology continues to evolve. For example, there are proposals in connection with the evolving IEEE 802.11bnUltra High Reliability (UHR) amendment (which is anticipated to be branded “Wi-Fi 8”) to enable seamless (hitless) roaming to improve the reliability of the Wi-Fi link. Some of these proposals leverage the Wi-Fi 7 Multi-Link Device (MLD) construct (i.e., a multi-radio client device and a collocated multi-radio AP device) with multiple simultaneously connected links) and extend the construct to a non-collocated multi-AP architecture to provide a better roaming experience. In this way, the multi-radio client device can access data from/to one or more of these physically distributed APs during the transition process and still be connected to the same WLAN Service Set ID (SSID) so as not to report a loss of connectivity to the upper stack (e.g., a connection manager user interface).

### BRIEF DESCRIPTION OF THE DRAWINGS

FIG. 1 shows a seamless mobility domain of a wireless local area network (WLAN) operating in accordance with Multi-Link Operation (MLO), including collocated and non-collocated APs and roaming logic hosted by several network elements, according to an example embodiment.

FIG. 2 depicts a sequence diagram illustrating a roaming operation, executed at least in part by the roaming logic, in a seamless mobility domain, according to an example embodiment.

FIG. 3 is a flowchart showing operations involving the roaming logic, according to an example embodiment.

FIG. 4 is a block diagram of a computing device that may be configured to host the roaming logic, and perform the techniques described herein, according to an example embodiment.

### DETAILED DESCRIPTION

### Overview

A method to facilitate roaming from a serving Access Point (AP) to a non-collocated AP is described. The method includes detecting, by an Access Point (AP) actor, that a communication metric characterizing communication between the AP actor and a non-AP actor is indicative of reduced communication quality, in response to detecting, sending a request, by the AP actor, to the non-AP actor for a beacon report for respective link metric values for a plurality of non-collocated AP actors, receiving, in response to the request and from the non-AP actor, the beacon report including the respective link metric values for the plurality of non-collocated AP actors, and based on the respective link metric values for the plurality of non-collocated AP actors, sending, by the AP actor, to the non-AP actor, a list of a subset of the plurality of non-collocated AP actors from which the non-AP actor may select to roam.

In another embodiment, a device is provided. The device includes an interface configured to enable network communications, a memory, and one or more processors coupled to the interface and the memory, and configured to detect that a communication metric characterizing communication with a non-Access Point (AP) actor is indicative of reduced communication quality, in response to detecting, send a request to the non-AP actor for a beacon report for respective link metric values for a plurality of non-collocated AP actors, receive, in response to the request and from the non-AP actor, the beacon report including the respective link metric values for the plurality of non-collocated AP actors, and based on the respective link metric values for the plurality of non-collocated AP actors, send to the non-AP actor, a list of a subset of the plurality of non-collocated AP actors from which the non-AP actor may select to roam.

### Example Embodiments

The described embodiments implement “seamless-ish” roaming by leveraging IEEE 802.11k/v/r features along with enhancements to implement make before break roaming (MBBR)-specific control-plane extensions. That is, a client mobile device may be connected to one or more APs at the same time and is capable of transitioning between them without re-association.

Architecturally, a traditional wireless LAN controller (WLC) is not a necessary component of a WLAN. In fact, it may be sufficient to more simply deploy an AP presenting an Ethernet interface to the network for user traffic and acting as its L2 interface (i.e., the port that learns the MACs bridged by it and responds to L2/L3 network control protocol (NCP) such as Address Resolution Protocol (ARP)/Reverse ARP (RARP), etc.). If mobility anchoring is desired, the AP and gateway (edge) can establish IEEE 802.11 agnostic L3 tunnels (e.g., Ethernet over IP (EoIP), Ethernet over Generic Routing Encapsulation (EoGRE), Ethernet over Multi-Protocol Label Switching (EoMPLS), etc.) on an aggregate (trunk) or individual MAC basis as desired. A notable feature is that mobility between physical APs is handled either via either a tunnel-less L2/Ethernet technique (L2 switch MAC learning, gratuitous ARP, etc.) or L3 tunnel technique whereby the tunnel end-point's move is initiated by the AP without the edge requiring any 802.1 1knowledge. Thus, and as will be explained in more detail below, MBBR is not employed on the edge device or AP Ethernet interfaces to store, forward or replicate MSDUs/MPDUs on one interface to another or split MSDUs between interfaces.

Instead, in accordance with an embodiment, the AP MLDs have a control-plane connection between themselves that controls which (set of collocated) APs in a multi-AP MLD set is serving the non-AP MLD (converting Ethernet to 802.11 frames and performing WiFi7 MLD functions), and this decision is triggered by the non-AP MLD's authentication-less 802.11r re-association process.

That is, in seamless and make-before-break-roaming (MBBR) architectures, the non-AP MLD does not need to associate with each target AP MLD as the association to any AP MLD in the same seamless mobility domain (SMD) replaces the need for future associations. The non-AP MLD simply adds a link from the target AP MLD into its MLD set and communication will be enabled.

The distinction between re-association and MLD add-link to establish communication is important since in the former all of the control and data-plane state is by definition erased/forgotten, meaning there is no connection state remembered, but in the latter case all of the non-AP MLD's connection state (but not necessarily data flow state) is automatically transferred to any target AP MLD and only the data-plane is reset (including block acknowledgement setup, as discussed below).

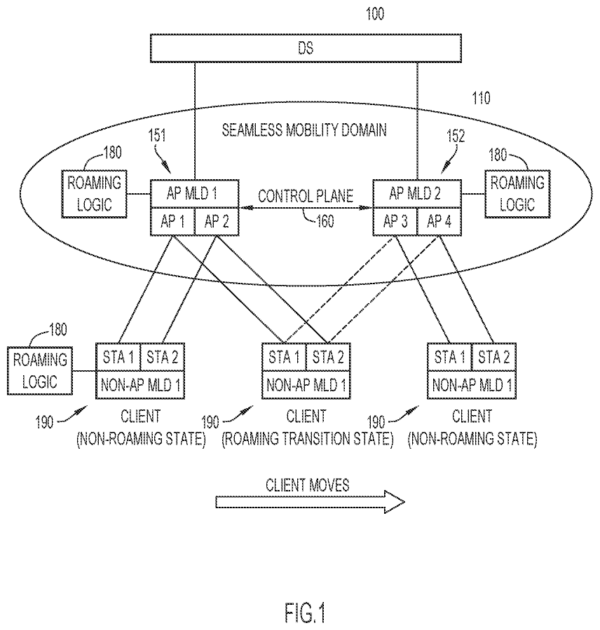

Reference is now made to FIG. 1, which shows a seamless mobility domain 110 of a wireless local area network (WLAN) operating in accordance with Multi-Link Operation (MLO), including collocated APs and non-collocated APs and roaming logic 180 hosted by several network elements, according to an example embodiment.

As shown, a distributed system (DS) 100 includes seamless mobility domain 110 that comprises AP MLD1 151 and AP MLD2 152. AP MLD1 151 includes AP1 and AP2, and AP MLD2 152 includes AP3 and AP4. AP MLD1 151 and AP MLD2 152 (and individual APs, namely AP1/AP2, AP3/AP4) may communicate with one another via a control plane 160. Roaming logic 180, the function of which is described further below, may be deployed on each of AP MLD1 151 and AP MLD2 152, as well as on a client 190. Roaming logic 180 could also be deployed as part of a WLAN controller (not shown). AP MLD1 151 and AP MLD2 152 may also be referred to as an “AP actor.”

Client 190 (which may also be referred to as a “non-AP MLD” or “non-AP actor”) includes non-AP MLD1, which itself includes STA1 and STA2, where STA1 and STA2 represent individual links or radios that communicate with, e.g., AP1, AP2, AP3, AP4. In the scenario depicted in FIG. 1, client 190 begins in a non-roaming state (on the left), moves to a roaming transition state (in the middle), and then ends, once again, in a non-roaming state (on the right), having roamed from AP MLD1 151 to AP MLD2 152 within the seamless mobility domain 110.

The seamless mobility domain 110 may be considered to be a multi-AP form of MLD AP logically comprising collocated APs (e.g., AP1 and AP2) and non-collocated APs (e.g., AP3 and AP4). Non-collocated APs (e.g., AP3 and AP4) may be physically on a different floor of a building or relatively far from AP1 and AP2. In a non-roaming state, a non-AP MLD (i.e., client 190, or “non-AP actor”) has a link set up, or established, with the currently serving co-located AP to avoid complexity of multiple data paths to DS 100.

During roaming transition, the non-AP MLD (i.e., client 190) has control-plane connectivity to the candidate target non-collocated APs via control plane 160 (but not data-plane connectivity).

In an embodiment, seamless mobility domain 110 is designated with a unique ID similar to a BSSID or 802.11r MDIE. Non-collocated APs (e.g., AP3, and AP4) (and collocated APs e.g., AP1, AP2) can be assigned a mobility domain-unique Link ID in the non-AP MLD's construct (just like a co-located AP) for the purpose of MLD link discovery and management. The mobility domain-unique Link ID may be a MAC address of the AP MLD plus a LinkID for a given AP (e.g., one AP1, AP2, AP3, AP4). Notably, non-collocated AP scanning is reduced/eliminated since their Beacon information is shared across the seamless mobility domain 110 via the control plane 160.

Thus, in an embodiment, a STA in non-AP MLD (e.g., client 190) first discovers, authenticates and associates with one AP (e.g., AP1 in AP MLD1 151) in the seamless mobility domain 110 (supportive of the desired SSID) which contains (from a Link ID and beacon management point of view) multiple links in non-collocated physical APs. The client 190 is aware of collocated (intra-AP) and non-collocated (inter-AP) links and only requests (e.g., association) or adds (e.g., link add) multiple collocated links as per Wi-Fi® 7 MLD operations. This WiFi7 era restriction is less flexible than data-path MBBR techniques (allowing simultaneous data delivery from both physical APs), but is relatively simple for the AP and network to realize. However, the discovery of these non-collocated APs via the seamless mobility domain 110 and assignment to an MLD Link ID solves a critical STA connectivity issue-that is: the STA is always “connected” to the WLAN (SSID) and need not break (dis-associate from one AP/AP MLD) before making (associate with a new AP/AP MLD) since all the APs are in the same seamless mobility domain. Furthermore, since beacons/management traffic can be sent to the client 190 via any active link in the seamless mobility domain 110, the STA in the non-AP MLD (client 190) does not need to ‘scan’ to determine the AP is suitable. In one embodiment, the non-AP MLD can use its inactive, power save (PS) state or Rx-only radio to verify, e.g., RSSI of directed candidate APs in the seamless mobility domain 110 without impacting MSDU delivery over its active link.

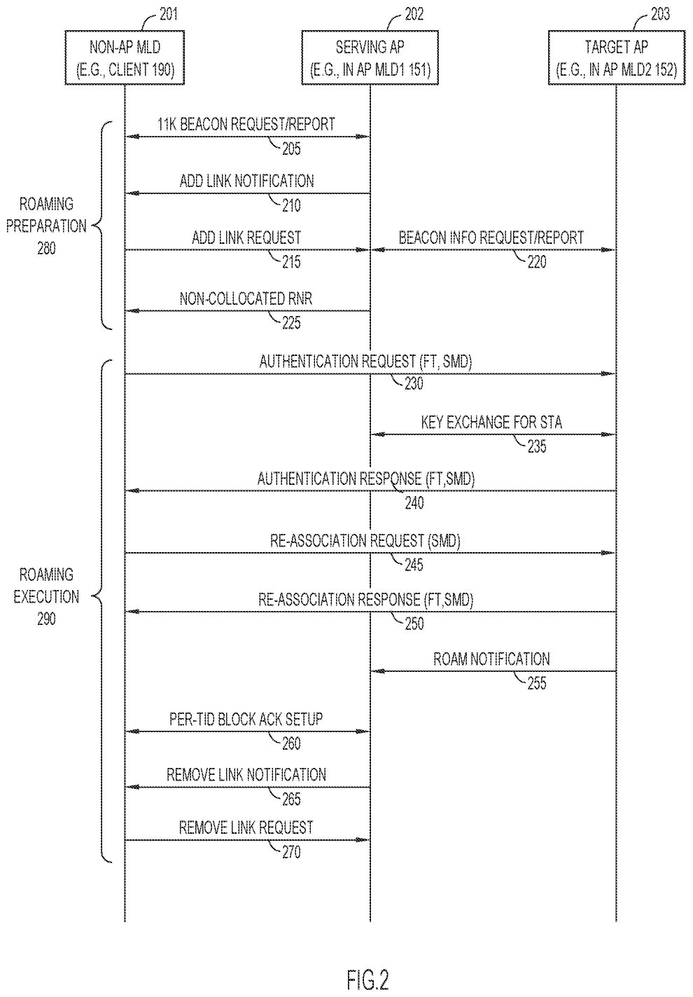

FIG. 2 depicts a sequence diagram illustrating a roaming operation in the seamless mobility domain 110, according to an example embodiment. The sequence diagram may be divided into two regions: roaming preparation 280 and roaming execution 290. Roaming logic 180 may be configured to execute the several functions described below.

### Roaming Preparation 280

As a result of failing communication between client 190 (non-AP actor) and a serving AP 202 (AP actor) indicated by, e.g., any of received signal strength (RSSI), congestion in the form of BSS load, direct measurement by client 190, a proportion of time the medium is busy, transmit wait time, number of retries, low modulation and coding scheme (MCS), at 205, serving AP 202 instructs a (STA of) non-AP MLD 201 to send an 802.11k Beacon Report for specific non-collocated APs (e.g., AP3, AP4) that are part of the seamless mobility domain 110 (based on, e.g., uplink RSSI, same floor of building, adjacent room or area, etc.). The beacon report includes link metric values for at least one of signal strength or signal quality values, such as received channel power indicator (RCPI) and received signal to noise indicator (RSNI).

Based on the link metric values, serving AP 202 determines candidate target non-collocated APs and, at 210, assigns them a Link ID valid in the non-AP MLD 201, and uses the IEEE 802.11be Add Link procedure, at 215, to add the non-collocated APs (e.g., target AP 203) to the non-AP MLD 201.

At 220, target APs, including target AP 203 (now with Link IDs in the non-AP MLD 201), report current link info (Beacon content, etc.) to the Serving AP 202, which relays to the non-AP MLD 201 via, at 225, a Reduced Neighbor Report (RNR) with non-collocated APs.

Non-AP MLD 201 uses this information to select target AP 203 (i.e., its Link ID) to roam to (including passive/active scanning, as needed (not shown)).

### Roaming Execution 290

At 230, an authentication request, i.e., IEEE 802.11r Fast Transition (FT) procedure within the seamless mobility domain 110 (SMD), is initiated to the target AP 203.

At 235, target AP 203 retrieves security metadata (key exchange data) as per IEEE 802.11r from the serving AP 202 to activate a new MAC instance for the non-AP MLD 201 (i.e., not based on the target AP MAC). At 240, an authentication response is sent from target AP 203 to non-AP MLD 201.

Then, at 245, non-AP MLD 201 initiates an IEEE 802.11 re-association request, (including re-establishing Block ACK) with now serving, target AP 203. At 250, now-serving target AP 203 sends a re-association response to non-AP MLD 201.

Both (a STA affiliated with) non-AP MLD 201 and now-serving target AP 203 maintain the same link membership state.

At 255, now-serving target AP 203 announces roaming success to other relevant APs (Link IDs) in SMD (e.g., (previously) serving AP 202), which now send Beacon information to it for distribution to the non-AP MLD 201.

At 260, (previously) serving AP 202 and non-AP MLD 201 set up per-TID (traffic ID) Block Acknowledgment.

At 265 and 270, serving AP 202 may prune irrelevant non-collocated AP from the MLD using IEEE 802.11be Delete link procedure.

Another way to understand the embodiments described herein is the following. In the methodology, constrained scanning is assumed (e.g., from an optimized Neighbor List) and is shown to achieve roaming of 5-10 msec (ms) with IEEE 802.11r.

Non-AP MLD 201 is configured to support:
IEEE 802.11k Radio Measurement Request/Report frames of mode Beacon Request/Report;
IEEE 802.11v basic service set (BSS) transition management (BTM) Request frame; and
IEEE 802.11r Fast Transition (FT).

When serving AP 202 detects that client 190 (non-AP MLD 201) has a weak or weakening transmission parameter value, such as RSSI or other communication metric noted above, the following steps may be executed.

Serving AP 202 requests a constrained non-collocated Beacon Report from the client (non-AP MLD 201) and the client responds with a Beacon Report listing the non-collocated APs in view (including a link metric, such as their RSSIs or signal to noise ratios).

Thereafter, the serving AP 202 sends a short, trimmed, list of preferred roaming AP candidates (e.g., non-collocated AP links in the MLD adjacent to or on, same floor, etc.) as Neighbor Report elements in at least one of a basic service set transition management (BTM) request frame (with Disassociation Imminent=0), a BTM query frame, or neighbor report response frame to the client (non-AP MLD 201).

Non-AP MLD 201 then initiates Fast Transition to roam to its preferred non-collocated AP MLD candidate (e.g., AP3 in AP MLD2 152, target AP 203) within the trimmed list.

In an embodiment, Fast Transition completion triggers the target AP 203 to assume the role as L2 interface for the MAC (e.g., gratuitous ARP, tunnel move, etc.) and the original AP (i.e., serving AP 202) to stop serving that role (i.e., via control signaling over control plane 160). It is noted that Fast Transition may be in accordance with IEEE 802.11r, along with supporting re-association within seamless mobility domain 110 (e.g., including any non-collocated AP MLDs in the AP MLD set).

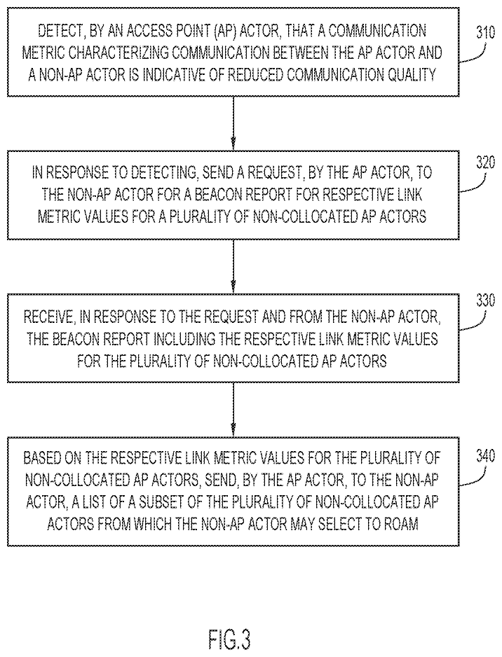

FIG. 3 is a flowchart showing operations involving roaming logic 180, according to an example embodiment. At 310, an operation is configured to detect, by an Access Point (AP) actor, that a communication metric characterizing communication between the AP actor and a non-AP actor is indicative of reduced communication quality. At 320, an operation is configured to, in response to detecting, send a request, by the AP actor, to the non-AP actor for a beacon report for respective link metric values for a plurality of non-collocated AP actors. At 330, an operation is configured to receive, in response to the request and from the non-AP actor, the beacon report including the respective link metric values for the plurality of non-collocated AP actors. And, at 340, an operation is configured to, based on the respective link metric values for the plurality of non-collocated AP actors, send, by the AP actor, to the non-AP actor, a list of a subset of the plurality of non-collocated AP actors from which the non-AP actor may select to roam.

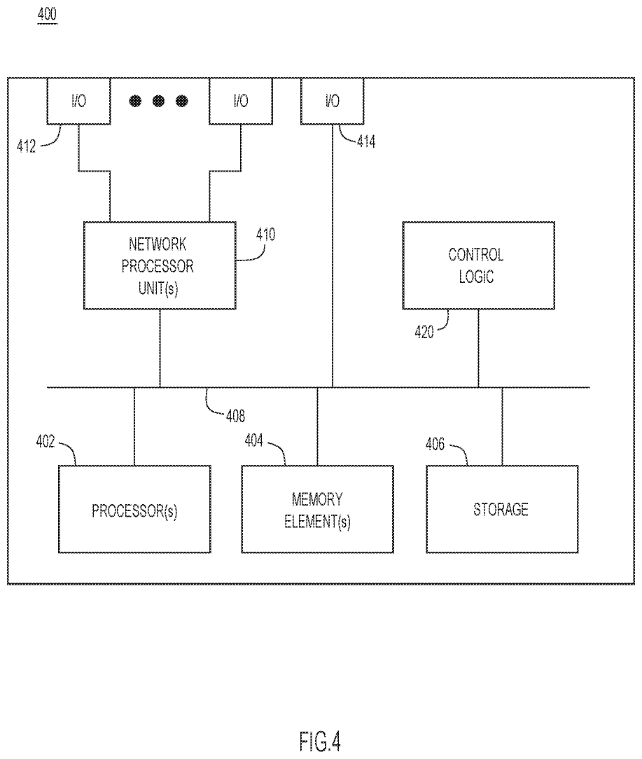

FIG. 4 is a block diagram of a computing device that may be configured to host and or execute roaming logic 180, and perform the techniques described herein, according to an example embodiment. In various embodiments, a computing device, such as computing device 400 or any combination of computing devices 400, may be configured as any entity/entities as discussed for the techniques depicted in connection with FIGS. 1-3 in order to perform operations of the various techniques discussed herein.

In at least one embodiment, the computing device 400 may include one or more processor(s) 402, one or more memory element(s) 404, storage 406, a bus 408, one or more network processor unit(s) 410 interconnected with one or more network input/output (I/O) interface(s) 412, one or more I/O interface(s) 414, and control logic 420 (which could include, for example, roaming logic 180. In various embodiments, instructions associated with logic for computing device 400 can overlap in any manner and are not limited to the specific allocation of instructions and/or operations described herein.

In at least one embodiment, processor(s) 402 is/are at least one hardware processor configured to execute various tasks, operations and/or functions for computing device 400 as described herein according to software and/or instructions configured for computing device 400. Processor(s) 402 (e.g., a hardware processor) can execute any type of instructions associated with data to achieve the operations detailed herein. In one example, processor(s) 402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 404 and/or storage 406 is/are configured to store data, information, software, and/or instructions associated with computing device 400, and/or logic configured for memory element(s) 404 and/or storage 406. For example, any logic described herein (e.g., control logic 420) can, in various embodiments, be stored for computing device 400 using any combination of memory element(s) 404 and/or storage 406. Note that in some embodiments, storage 406 can be consolidated with memory element(s) 404 (or vice versa) or can overlap/exist in any other suitable manner.

In at least one embodiment, bus 408 can be configured as an interface that enables one or more elements of computing device 400 to communicate in order to exchange information and/or data. Bus 408 can be implemented with any architecture designed for passing control, data and/or information between processors, memory elements/storage, peripheral devices, and/or any other hardware and/or software components that may be configured for computing device 400. In at least one embodiment, bus 408 may be implemented as a fast kernel-hosted interconnect, potentially using shared memory between processes (e.g., logic), which can enable efficient communication paths between the processes.

In various embodiments, network processor unit(s) 410 may enable communication between computing device 400 and other systems, entities, etc., via network I/O interface(s) 412 (wired and/or wireless) to facilitate operations discussed for various embodiments described herein. In various embodiments, network processor unit(s) 410 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 400 and other systems, entities, etc. to facilitate operations for various embodiments described herein. In various embodiments, network I/O interface(s) 412 can be configured as one or more Ethernet port(s), Fibre Channel ports, any other I/O port(s), and/or antenna(s)/antenna array(s) now known or hereafter developed. Thus, the network processor unit(s) 410 and/or network I/O interface(s) 412 may include suitable interfaces for receiving, transmitting, and/or otherwise communicating data and/or information in a network environment.

I/O interface(s) 414 allow for input and output of data and/or information with other entities that may be connected to computing device 400. For example, I/O interface(s) 414 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 420 can include instructions that, when executed, cause processor(s) 402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 404 and/or storage 406 can store data, software, code, instructions (e.g., processor instructions), logic, parameters, combinations thereof, and/or the like used for operations described herein. This includes memory element(s) 404 and/or storage 406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include detecting, by an Access Point (AP) actor, that a communication metric characterizing communication between the AP actor and a non-AP actor is indicative of reduced communication quality, in response to detecting, sending a request, by the AP actor, to the non-AP actor for a beacon report for respective link metric values for a plurality of non-collocated AP actors, receiving, in response to the request and from the non-AP actor, the beacon report including the respective link metric values for the plurality of non-collocated AP actors, and based on the respective link metric values for the plurality of non-collocated AP actors, sending, by the AP actor, to the non-AP actor, a list of a subset of the plurality of non-collocated AP actors from which the non-AP actor may select to roam.

The method may further include defining a mobility domain that includes the AP actor and the plurality of non-collocated AP actors, and enabling control plane communication among the AP actor and the plurality of non-collocated AP actors.

The method may further include assigning a mobility domain-unique link ID to teach AP in the AP actor and to each AP in the plurality of non-collocated AP actors.

In the method, the list of the subset of the plurality of non-collocated AP actors may include respective mobility domain-unique link IDs corresponding to APs in the plurality of non-collocated AP actors.

In the method, the AP actor and the non-collocated AP actors may be multi-link devices (MLDs).

In the method, the link metric values may include at least one of signal strength or signal quality values. (RCPI-received channel power indicator RSNI received signal to noise indicator.

In the method, sending the list of a subset of the plurality of non-collocated AP actors from which the non-AP actor may select to roam may include sending the list via a neighbor report element in at least one of a basic service set transition management (BTM) request frame, a BTM query frame, or neighbor report response frame.

The method may further include executing, with the non-AP actor, a roaming procedure by a selected one of the plurality of non-collocated AP actors on the list.

The method may further include, after the non-AP actor roams to an AP in the plurality of non-collocated AP actors, one of the AP actor or non-AP actor initiating a remove link procedure between the AP actor and the non-AP actor.

In the method, the non-AP actor may verify the respective link metric values associated with the plurality of non-collocated AP actors while in a power save mode.

In another embodiment, a device may be provided and may include an interface configured to enable network communications, a memory, and one or more processors coupled to the interface and the memory, and configured to: detect that a communication metric characterizing communication with a non-Access Point (AP) actor is indicative of reduced communication quality, in response to detecting, send a request to the non-AP actor for a beacon report for respective link metric values for a plurality of non-collocated AP actors, receive, in response to the request and from the non-AP actor, the beacon report including the respective link metric values for the plurality of non-collocated AP actors, and based on the respective link metric values for the plurality of non-collocated AP actors, send to the non-AP actor, a list of a subset of the plurality of non-collocated AP actors from which the non-AP actor may select to roam.

In the device, the one or more processors may be further configured to: define a mobility domain that includes the device as an AP actor and the plurality of non-collocated AP actors, and enable control plane communication among the AP actor and the plurality of non-collocated AP actors.

In the device, the one or more processors may be further configured to assign a mobility domain-unique link ID to each AP in the AP actor and to each AP in the plurality of non-collocated AP actors.

In the device, the list of the subset of the plurality of non-collocated AP actors may include respective mobility domain-unique link IDs corresponding to APs in the plurality of non-collocated AP actors.

In the device, the AP actor and the non-collocated AP actors may be multi-link devices (MLDs).

In the device, the link metric values may include at least one of signal strength values or signal quality values.

In the device, the one or more processors may be further configured to send the list of a subset of the plurality of non-collocated AP actors from which the non-AP actor may select to roam by sending the list via a neighbor report element in at least one of a basic service set transition management (BTM) request frame, a BTM query frame, or neighbor report response frame.

In yet another embodiment, one or more non-transitory computer readable storage media encoded with instructions are provided and that, when executed by a processor, cause the processor to detect, by an Access Point (AP) actor, that a communication metric characterizing communication between the AP actor and a non-AP actor is indicative of reduced communication quality, in response to detecting,, send a request, by the AP actor, to the non-AP actor for a beacon report for respective link metric values for a plurality of non-collocated AP actors, receive, in response to the request and from the non-AP actor, the beacon report including the respective link metric values for the plurality of non-collocated AP actors, and based on the respective link metric values for the plurality of non-collocated AP actors, send, by the AP actor, to the non-AP actor, a list of a subset of the plurality of non-collocated AP actors from which the non-AP actor may select to roam.

The one or more non-transitory computer readable storage media may further instructions that are configured to: define a mobility domain that includes the AP actor and the plurality of non-collocated AP actors, and enable control plane communication among the AP actor and the plurality of non-collocated AP actors.

The one or more non-transitory computer readable storage media may further include instructions that are configured to assign a mobility domain-unique link ID to each AP in the AP actor and to each AP in the in the plurality of non-collocated AP actors.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
detecting, by an Access Point (AP) actor, that a communication metric characterizing communication between the AP actor and a non-AP actor is indicative of reduced communication quality;
in response to detecting, sending a request, by the AP actor, to the non-AP actor for a beacon report for respective link metric values for a plurality of non-collocated AP actors;
receiving, in response to the request and from the non-AP actor, the beacon report including the respective link metric values for the plurality of non-collocated AP actors; and
based on the respective link metric values for the plurality of non-collocated AP actors, sending, by the AP actor, to the non-AP actor, a list of a subset of the plurality of non-collocated AP actors from which the non-AP actor may select to roam.

2. The method of claim 1, further comprising:
defining a mobility domain that includes the AP actor and the plurality of non-collocated AP actors; and
enabling control plane communication among the AP actor and the plurality of non-collocated AP actors.

3. The method of claim 2, further comprising assigning a mobility domain-unique link ID to teach AP in the AP actor and to each AP in the plurality of non-collocated AP actors.

4. The method of claim 3, wherein the list of the subset of the plurality of non-collocated AP actors comprises respective mobility domain-unique link IDs corresponding to APs in the plurality of non-collocated AP actors.

5. The method of claim 2, wherein the AP actor and the non-collocated AP actors are multi-link devices (MLDs).

6. The method of claim 1, wherein the link metric values are comprised of at least one of signal strength or signal quality values. (RCPI-received channel power indicator RSNI received signal to noise indicator.

7. The method of claim 1, wherein sending the list of a subset of the plurality of non-collocated AP actors from which the non-AP actor may select to roam comprises sending the list via a neighbor report element in at least one of a basic service set transition management (BTM) request frame, a BTM query frame, or neighbor report response frame.

8. The method of claim 1, further comprising executing, with the non-AP actor, a roaming procedure by a selected one of the plurality of non-collocated AP actors on the list.

9. The method of claim 1, further comprising, after the non-AP actor roams to an AP in the plurality of non-collocated AP actors, one of the AP actor or non-AP actor initiating a remove link procedure between the AP actor and the non-AP actor.

10. The method of claim 1, wherein the non-AP actor verifies the respective link metric values associated with the plurality of non-collocated AP actors while in a power save mode.

11. A device comprising:
an interface configured to enable network communications;
a memory; and
one or more processors coupled to the interface and the memory, and configured to:
detect that a communication metric characterizing communication with a non-Access Point (non-AP) actor is indicative of reduced communication quality;
in response to detecting, send a request to the non-AP actor for a beacon report for respective link metric values for a plurality of non-collocated AP actors;
receive, in response to the request and from the non-AP actor, the beacon report including the respective link metric values for the plurality of non-collocated AP actors; and
based on the respective link metric values for the plurality of non-collocated AP actors, send to the non-AP actor, a list of a subset of the plurality of non-collocated AP actors from which the non-AP actor may select to roam.

12. The device of claim 11, wherein the one or more processors are further configured to:
define a mobility domain that includes the device as an AP actor and the plurality of non-collocated AP actors; and
enable control plane communication among the AP actor and the plurality of non-collocated AP actors.

13. The device of claim 12, wherein the one or more processors are further configured to assign a mobility domain-unique link ID to each AP in the AP actor and to each AP in the plurality of non-collocated AP actors.

14. The device of claim 13, wherein the list of the subset of the plurality of non-collocated AP actors comprises respective mobility domain-unique link IDs corresponding to APs in the plurality of non-collocated AP actors.

15. The device of claim 12, wherein the AP actor and the non-collocated AP actors are multi-link devices (MLDs).

16. The device of claim 11, wherein the link metric values are comprised of at least one of signal strength values or signal quality values.

17. The device of claim 11, wherein the one or more processors are further configured to send the list of a subset of the plurality of non-collocated AP actors from which the non-AP actor may select to roam by sending the list via a neighbor report element in at least one of a basic service set transition management (BTM) request frame, a BTM query frame, or neighbor report response frame.

18. One or more non-transitory computer readable storage media encoded with instructions that, when executed by a processor, cause the processor to:
detect, by an Access Point (AP) actor, that a communication metric characterizing communication between the AP actor and a non-AP actor is indicative of reduced communication quality;
in response to detecting,, send a request, by the AP actor, to the non-AP actor for a beacon report for respective link metric values for a plurality of non-collocated AP actors;
receive, in response to the request and from the non-AP actor, the beacon report including the respective link metric values for the plurality of non-collocated AP actors; and
based on the respective link metric values for the plurality of non-collocated AP actors, send, by the AP actor, to the non-AP actor, a list of a subset of the plurality of non-collocated AP actors from which the non-AP actor may select to roam.

19. The one or more non-transitory computer readable storage media of claim 18, wherein the instructions are configured to:
define a mobility domain that includes the AP actor and the plurality of non-collocated AP actors; and
enable control plane communication among the AP actor and the plurality of non-collocated AP actors.

20. The one or more non-transitory computer readable storage media of claim 19, wherein the instructions are configured to assign a mobility domain-unique link ID to each AP in the AP actor and to each AP in the in the plurality of non-collocated AP actors.
